(19) United States
(12) Patent Application Publication
(10) Pub. No.: US 2003/0145136 A1
(43) Pub. Date: Jul. 31, 2003

(54) Method and apparatus for implementing a relaxed ordering model in a computer system

(76) Inventors: Gregory E. Tierney, Chelmsford, MA (US); Thomas J. Gibney, Watertown, MA (US); Stephen R. Van Doren, Northborough, MA (US)

Correspondence Address: CESARI AND MCKENNA, LLP, 88 BLACK FALCON AVENUE, BOSTON, MA, 02210, US

(21) Appl. No.: 10/066,534

(22) Filed: Jan. 31, 2002

(51) Int. Cl. G06F 3/00

(52) U.S. Cl. 710/3

(57) ABSTRACT

An ordering engine is configured to implement a relaxed ordering consistency model for a stream of I/O transactions initiated in a computer system. The ordering engine examines the relaxed ordering attribute of the transactions in the stream to distinguish payload transactions, which may be processed out of order, from control transaction which must be processed in strict order. The engine preferably organizes the stream of transactions into epochs, where the receipt of a first relaxed order write operation in the stream constitutes the start of an epoch and the receipt of a first strict order operation in the stream constitutes the conclusion of the epoch. The engine is configured to delay the completion of the strict order operation constituting the conclusion of the epoch until all payload write operations issued during the epoch have committed.

### BACKGROUND OF THE INVENTION

1. Field of the Invention

This invention relates to computer architectures and, more specifically, to a system for implementing relaxed ordering of input/output (I/O) transactions.

2. Background Information

Symmetrical Multiprocessor (SMP) Systems

Multiprocessor computing systems, such as symmetrical multiprocessor (SMP) systems, provide a computer environment in which software applications may run on a plurality of processors using a single address space or shared memory abstraction. In a shared memory system, each processor can access any data item without a programmer having to worry about where the data is or how to obtain its value. This frees the programmer to focus on program development rather than on managing partitioned data sets and communicating values.

Interprocessor synchronization is typically accomplished in a shared memory system between processors performing read and write operations to “synchronization variables” either before and after accesses to “data variables”. For instance, consider the case of a first processor P1 updating a data structure and a second processor P2 reading the updated structure after synchronization. Typically, this is accomplished by P1 updating data values and subsequently setting a semaphore or flag variable to indicate to P2 that the data values have been updated. P2 checks the value of the flag variable and, if set, subsequently issues read operations (requests) to retrieve the new data values. If P1 sets the flag before it completes the data updates or if P2 retrieves the data before it checks the value of the flag, synchronization is not achieved. The key is that each processor must individually impose an order on its memory references for such synchronization techniques to work. The order described above is referred to as a processor's inter-reference order. Commonly used synchronization techniques require that each processor be capable of imposing an inter-reference order on its issued memory reference operations.

The inter-reference order imposed by a processor is defined by its memory reference ordering model or, more commonly, its consistency model. The consistency model for a processor architecture specifies, in part, a means by which the inter-reference order is specified. Typically, the means is realized by inserting a special memory reference ordering instruction, such as a Memory Barrier (MB) or “fence”, between sets of memory reference instructions. Alternatively, the means may be implicit in other operation codes (opcodes), such as in “test-and-set”. Two commonly used consistency models include sequential consistency and weak-ordering, although other models may be employed, such as release consistency.

To increase performance, modern processors do not execute memory reference instructions one at a time. It is desirable that a processor keep a large number of memory references outstanding and issue, as well as complete, memory reference operations out-of-order. This is accomplished by viewing the consistency model as a “logical order”, i.e., the order in which memory reference operations appear to happen, rather than the order in which those references are issued or completed. More precisely, a consistency model defines only a logical order on memory references. It allows for a variety of optimizations in implementation. It is thus desired to increase performance by reducing latency and allowing (on average) a large number of outstanding references, while preserving the logical order implied by the consistency model.

In prior systems, a memory barrier instruction is typically passed upon “completion” of an operation. For example, when a source processor issues a read operation, the operation is considered complete when data is received at the source processor. When executing a store instruction, the source processor issues a memory reference operation to acquire exclusive ownership of the data. In response, system control logic generates “probes” to invalidate old copies of the data at other processors and to request forwarding of the data from the owner processor to the source processor. Here, the operation completes only when all probes reach their destination processors and the data is received at the source processor. Prior systems thus rely on completion to impose inter-reference ordering. That is, in a weakly-ordered system employing MB instructions, all pre-MB operations must be complete before the MB is passed and before any post-MB operations may be considered.

Input/Output (I/O) Devices

Connected to most computer systems, including symmetrical multiprocessor (SMP) systems, are a plurality of input/output (I/O) devices or peripheral components, such as disk drives, tape drives, graphics accelerators, audio cards, network interface cards (NICs), etc. The peripheral components are typically connected to an input/output (I/O) bus operating in accordance with a bus standard, such as Industry Standard Architecture (ISA), Extended ISA (EISA), and Peripheral Components Interface (PCI), among others. In most computer systems, the processor bus to which the processor(s) and the main memory are connected often runs at a higher speed than the I/O bus. Accordingly, a separate device, referred to as an I/O host or bridge, is used to interface between the processor and memory which are attached to the processor bus, and the peripheral components which are attached to the I/O bus. The I/O bridge basically moves transactions, e.g., Direct Memory Access (DMA) reads and writes, between the processor bus and the I/O bus.

Read and write transactions to or from I/O devices on a PCI bus can be classified as either payload or control. For a write operation, transactions carrying the data to be written are payload, while the transaction carrying the flag indicating that the data has been written (and may now be read) is control. Similarly, a transaction carrying a status, which is typically sourced by a processor and indicates that the data has been consumed, is also control.

Since I/O devices interact with the processors of a SMP system, a consistency model must be specified for these interactions. I/O devices typically expect sequentially consistent behavior with respect to their memory reference operations. That is, an I/O device expects each read and write operation issued by it to at least appear as if it is executed by the I/O bridge and the SMP system in the order issued by the device. The I/O bridge, in turn, must issue and complete these memory reference operations in such a way that the logical order is preserved.

A typical approach to ensuring sequential consistency is for the I/O bridge to “complete” each previous operation from an I/O device before issuing a subsequent operation from that device. Essentially, “completion of an operation” requires actual completion of all activity, including receipt of data and acknowledgments, corresponding to the operation. Such an arrangement, however, is inefficient and adversely affects latency.

U.S. Pat. No. 6,085,263, issued Jul. 4, 2000, which is commonly owned with the present application, discloses a method for maintaining inter-reference ordering of operations issued by I/O devices in a SMP system. Specifically, the '263 patent describes an I/O processor (IOP) that includes a prefetch controller coupled to an I/O cache, and a retire controller that imposes inter-reference ordering on I/O operations based on the receipt of a commit signal. According to the method of the '263 patent, prefetching operations may be performed by the SMP system in an arbitrary manner, e.g., out-of-order, thereby realizing the advantages of a shared memory SMP system. Nonetheless, the retire controller ensures that, from the point of view of the I/O devices, the operations appear to have been processed in strict order.

PCI-X Bus Standard

Recently, an extension to the PCI bus standard, commonly referred to as the PCI-X standard, has been developed. The PCI-X bus standard, which provides for a bus width of 64 bits and a bus frequency of 133.3 MHz, represents a significant improvement over conventional PCI. In addition to the increase in bus operating speed, the PCI-X bus standard also defines several new features. Specifically, the PCI-X standard defines a new bus transaction phase called the “attribute phase”. The attribute phase uses a 36-bit attribute message which the initiator of a transaction drives onto the I/O bus immediately after the address phase. The attribute message contains several fields specifying information about the size of the transaction, the ordering of transactions, and the identity of the transaction initiator.

FIG. 1 is a highly schematic block diagram of a PCI-X attribute message 100 associated with a DWORD transaction. A DWORD is a 32-bit block of data aligned on four-byte boundaries. The attribute field 100 includes a 4-bit byte enables field 102, which is set to indicate which of the four bytes of the DWORD contain valid data, a reserved (R) field 104, a no snoop (NS) field 106, a 1-bit relaxed ordering (RO) field 108, and a 5-bit tag field 110. The attribute message 100 further includes a requester bus number field 112, that contains the requester's bus number in case the transaction crosses more than one I/O bus, a requester device number field 114, that contains the identification (ID) number assigned to the requester, a 3-bit requester function number field 116, that contains an ID number assigned to the particular requesting function within the device, and a reserved (RES) field 118.

The Relaxed Ordering attribute of field 108 allows certain ordering requirements to be indicated explicitly on a transaction-by-transaction basis. More specifically, when an I/O device, asserts, e.g., sets to “1”, the RO field 108, then the corresponding transaction need not be completed in strict order. In other words, it may be completed out of order. If the RO field 108 is set for a read transaction, the completion of the read is permitted to pass previously posted memory write transactions that are traveling in the same direction as the read completion, i.e., travelling to the requesting device. If the RO field 108 is set for a write transaction, it is permitted to pass previously posted memory write transactions moving in the same direction in the host bridge. Thus, a write to one memory controller is not required to wait for the completion of previous writes to another memory controller.

If the RO bit 108 is de-asserted, e.g., not set or cleared, then the corresponding transaction requires strict ordering with respect to all previous and, in some circumstances, some subsequent transactions. Transactions subject to strict ordering cannot be issued to a computer's memory system until all prior transactions have reached a state of completion.

An I/O device may assert the RO bit 108 for all payload write transactions and then, generate a separate control transaction for a flag write in which the RO bit 108 is de-asserted. Thus, when multiple payload writes are required, the individual write transactions may be issued to the memory system in parallel, while the control write is withheld until all payload writes complete.

The PCI-X specification does not, however, describe how a computer system might be designed so as to take advantage of relaxed ordering. Accordingly, a need exists for a system capable of taking advantage of the Relaxed Ordering attribute of PCI-X transactions. A need also exists for a Relaxed Ordering system that can efficiently inter-operate with high-performance, shared memory computer architectures, such as SMP computer systems.

### SUMMARY OF THE INVENTION

Briefly, the present invention is directed to an ordering engine for implementing a relaxed ordering consistency model. In the illustrative embodiment, the ordering engine is disposed at an input/output (I/O) bridge or processor (IOP) of a symmetrical multiprocessor (SMP) computer system. The IOP is configured to handle I/O transactions between I/O devices and the system. The ordering engine examines the relaxed ordering attribute of transactions and permits transactions for which the relaxed ordering attribute is set, so-called payload, transactions, to be completed out of order, while keeping transactions for which the relaxed ordering attribute is not set, so-called control transactions, in strict order. The ordering engine also ensures that control transactions push previously issued write transactions.

The SMP system may comprise a node having a plurality of processors, one or more IOPs and a shared memory that are all are interconnected by a local switch. In another embodiment, the SMP system may comprise a plurality of such nodes interconnected by a hierarchical switch. Each processor preferably has a private cache for storing data and changes to the data as a result of the memory reference operations. In addition, ownership requests are reflected among the entities via the transmission of probe commands in accordance with a conventional cache coherence protocol. Associated with the SMP system is at least one ordering point. For the SMP node, the ordering point is associated with the local switch. In the multi-node SMP system, the ordering point is associated with the hierarchical switch. The ordering point of the SMP system totally orders each memory reference operation with respect to other issued references using, e.g., a conventional arbitration or prioritization policy. The ordering point typically generates probes to invalidate any copies of the data at appropriate processors or IOPs and/or to request forwarding of the data from the owner processor or IOP to the requesting processor or IOP, as required by the memory operation. Significantly, the ordering point also generates the commit-signal for transmission to the requesting processor or IOP. Probes and commit signals are generated atomically for transmission to the appropriate processors or IOPs. The net result is that all memory operations appear totally ordered.

The ordering engine preferably includes a prefetch controller coupled to an I/O cache for prefetching data into the I/O cache without any order. It further includes a retire queue operably coupled to an ordering controller, an epoch state machine, an epoch identifier (ID) generator, an epoch counter, an epoch register, and a plurality of payload commit pending counters. The epoch state machine is configured to transition between two possible states: last_was_control and last_was_payload. The epoch counter is configured to flow control the issuance of payload transactions from multiple epochs, as the maximum number of epochs that can concurrently be processed in the system is equal to the number of payload commit pending counters. In the illustrative embodiment, this maximum is also the number of unique identifiers provided by the epoch ID generator.

Upon receipt of a write transaction having the relaxed ordering attribute set (a payload write), the queue controller examines the state of the epoch state machine. If the current state is last_was_control and the epoch counter is less than a predefined maximum value, the state is transitioned to last_was_payload, and the epoch ID generator returns a new epoch ID. In addition, the epoch counter is incremented, and a payload commit pending counter is assigned to the newly generated epoch ID and it is incremented. Next, the epoch ID is appended to the write transaction which is then forwarded to the system for processing. If the current state is last_was_payload, then the state is not transitioned, the payload commit pending counter for the current epoch ID is incremented and the current epoch ID is appended to the write transaction which is similarly forwarded to the system for processing.

If the current state is last_was_control and the epoch counter is equal to the maximum value, then there are insufficient epoch resources for the ordering engine to establish a new epoch for the payload write transaction. In this case, the state of the epoch state machine is not transitioned to last_was_payload. Instead, the relaxed ordering attribute of the transaction is cleared, thereby converting the transaction to a control transaction. The strict ordering rules are then applied to the converted transaction. Alternatively, the ordering engine may be configured to stall in response to epoch resources being fully allocated. That is, the payload write transaction and all subsequently issued transactions are held rather than forwarded until epoch resources again become available. The availability of epoch resources is reflected by the epoch counter falling below the maximum value.

Read transactions whose relaxed ordering attribute is set (a payload read) are simply forwarded to the system for processing.

Upon receipt of a control transaction (any transaction in which the relaxed ordering attribute is not set or any transaction in which the relaxed ordering attribute was cleared due to the unavailability of epoch resources), the queue controller examines the state of the epoch state machine. If the current state is last_was_control, the control transaction is forwarded to the system for processing and a copy of the control transaction along with the current epoch ID is placed at the tail of the retire queue. If the current state is last_was_payload, the state is transitioned to last_was_control. The control transaction is then forwarded to the system for processing and a copy of the transaction along with the current epoch ID is similarly placed at the tail of the retire queue.

For each transaction, a commit signal is preferably returned to the IOP by the ordering point of the SMP system. If an epoch ID was appended to the transaction, the ordering point appends the same epoch ID to the respective commit signal. Commit signals are necessary prerequisites for retiring control transactions, but not for retiring payload transactions. Commit signals returned for payload write transactions, however, are utilized to determine the consistency requirement for a control transaction from the same epoch. Commit signals returned for payload read transactions, if any, are ignored.

The ordering controller also retires control transactions from the retire queue. Only the transaction currently at the head of the retire queue is eligible for retirement. To retire the control transaction from the head of the retire queue several conditions must be satisfied. First, the payload commit pending counter associated with the epoch ID assigned to the control transaction must be zero. By waiting until the corresponding commit pending counter reaches zero, the ordering controller “knows” that all payload write transactions issued before the subject control transaction have completed. Second, the commit signal for the control transaction must have been received by the IOP. If either of these conditions are false, then the control transaction cannot be removed from, e.g., “popped off”, the retire queue nor can any control transactions below this transaction be removed.

Additionally, the epoch register is used to record the epoch ID associated with the last transaction to have been “popped off” the retire queue. The completion of an epoch occurs when the value stored at the epoch register no longer matches the epoch ID associated with the transaction at the head of the retire queue. When the first control transaction associated with new epoch is popped off the retire queue, the ordering controller also decrements the epoch counter. The resources used by a completed epoch, i.e., the epoch ID and the corresponding payload commit pending counter, are then made available for reuse by a subsequent epoch.

### BRIEF DESCRIPTION OF THE DRAWINGS

The invention description below refers to the accompanying drawings, of which:

FIG. 1, previously discussed, is a highly schematic block diagram of a PCI-X attribute message;

FIG. 2 is a schematic block diagram of a multiprocessor node in accordance with a preferred embodiment of the present invention;

FIG. 3 is a schematic block diagram of the local switch comprising a plurality of ports coupled to the respective processors of FIG. 2;

FIG. 4 is a schematic diagram of an embodiment of a commit-signal implemented as a commit-signal packet;

FIG. 5 is a schematic block diagram of a multiprocessing system in accordance with another embodiment of the present invention;

FIG. 6 is a schematic block diagram of an augmented multiprocessor node comprising a plurality of processors interconnected with a shared memory, an IOP and a global port interface via a local switch;

FIG. 7 is a schematic diagram of a high-performance input/output processor (IOP) including a relaxed ordering engine in accordance with the present invention;

FIG. 8 is a schematic diagram of a cache entry of the I/O cache of FIG. 7; and

FIGS. 9A-E are a flow diagram of a method of the present invention.

### DETAILED DESCRIPTION OF AN ILLUSTRATIVE EMBODIMENT

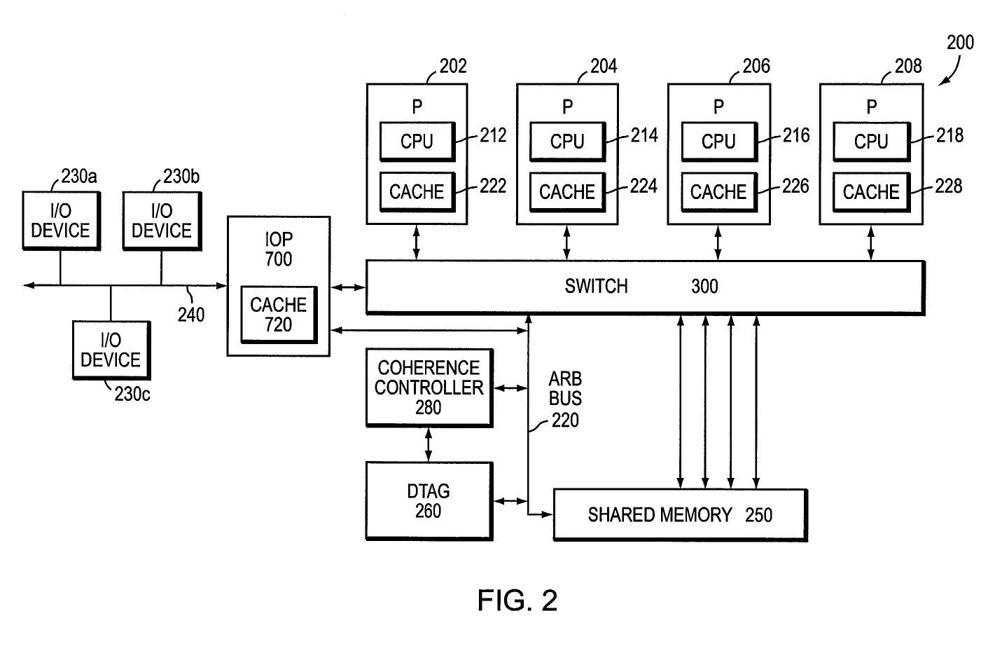

FIG. 2 is a schematic block diagram of a symmetrical multiprocessor (SMP) system, such as a SMP node 200 that has a plurality of processors (P) 202-208 coupled to an input/output (I/O) processor 700 and a shared memory 250 by a local switch 300. The memory 250 is preferably organized as a single address space that is shared by the processors and apportioned into a number of blocks or lines, each of which may include, e.g., 64 bytes of data. The I/O processor (IOP) or bridge 700 controls the transfer of data among external devices, such as I/O devices 230a-c, and the system via an I/O bus 240. Data is transferred between the components of the SMP node 200 in the form of packets. As used herein, the term “system” refers to all components of the SMP node 200 excluding the processors 202-208 and the IOP 700. In an embodiment of the invention, the I/O bus may operate according to the conventional Peripheral Computer Interconnect Extended (PCI-X) protocol.

Each processor preferably includes a central processing unit (CPU), denoted 212-218, that preferably incorporates a traditional reduced instruction set computer (RISC) load/store architecture. In the illustrative embodiment described herein, the CPUs 212-218 are Alpha® 21264 processor chips manufactured by Compaq Computer Corporation of Houston, Tex., although other types of processor chips may be advantageously used, such as those manufactured by Intel Corporation of Santa Clara, Calif. and by Advanced Micro Devices, Inc. (AMD) of Sunnyvale, Calif., among others. The load/store instructions executed by the processors are issued to the system as memory reference, e.g., read and write, operations. Each operation may comprise a series of commands (or command packets) that are exchanged between the processors and the system. As described further herein, characteristics of modem processors include the ability to issue memory reference operations out-of-order, to have more than one memory reference outstanding at a time and to accommodate completion of the memory reference operations in arbitrary order.

In addition, each processor and IOP employs a private cache, denoted 222-228 and 720, respectively, for storing data determined likely to be accessed in the future. The caches are preferably organized as write-back caches apportioned into, e.g., 64-byte, cache lines accessible by the processors 202-208. It should be noted, however, that other cache organizations, such as write-through caches, may be used. It should be further noted that memory reference operations issued by the processors 202-208 are preferably directed to a 64-byte cache line granularity. Since the IOP 700 and processors 202-208 may update data in their private caches without updating shared memory 250, a cache coherence protocol is utilized to maintain consistency among the caches.

The cache coherence protocol of the illustrative embodiment is preferably a conventional write-invalidate, ownership-based protocol. “Write-Invalidate” implies that when a processor modifies a cache line, it invalidates stale copies in other processors' caches rather than updating them with the new value. The protocol is termed an “ownership protocol” because there is always an identifiable owner for a cache line, whether it is shared memory, one of the processors 202-208 or the IOP 700. The owner of the cache line is responsible for supplying the up-to-date value of the cache line when requested. A processor or an IOP may own a cache line in one of two states: “exclusively” or “shared”. If a processor or IOP has exclusive ownership of a cache line, it may update it without informing the system. Otherwise, it must inform the system and potentially invalidate copies in the other caches.

A shared data structure 260 is provided for capturing and maintaining status information corresponding to the states of data used by the system 200. In the illustrative embodiment, the shared data structure is configured as a conventional duplicate tag store (DTAG) 260 that cooperates with the individual caches of the system 200 to define the coherence protocol states of the data in the system. The protocol states of the DTAG 260 are administered by a coherence controller 280, which may be implemented as a plurality of hardware registers and combinational logic configured to produce a sequential logic circuit, such as a state machine. It should be noted, however, that other configurations of the controller and shared data structure may be advantageously used herein.

The DTAG 260, coherence controller 280, IOP 700 and shared memory 250 are interconnected by a logical bus referred to an Arbitration (Arb) bus 270. Memory reference operations issued by the processors 202-208 are routed via the local switch 300 to the Arb bus 270. The order in which the actual memory reference commands appear on the Arb bus 270 is the order in which processors perceive the results of those commands. The Arb bus 270 and the coherence controller 280 cooperate to provide an ordering point, as described herein.

The commands described herein are defined by the Alpha® memory system interface and may be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commands, Read/Modify (RdMod) commands, Change-to-Dirty (CTD) commands, Victim commands, and Evict commands, the latter of which specify removal of a cache line from a respective cache.

Probes are commands issued to one or more processors 202-208 that request data and/or cache tag status updates. Probes include Forwarded Read (FRd) commands, Forwarded Read Modify (FRdMod) commands and Invalidate (Inval) commands. When a processor P issues a request, one or more probes (via probe packets) may be issued to other processors. For example, if P requests a copy of a cache line (a Rd request), a probe is sent to the owner processor (if any). If P requests exclusive ownership of a cache line (a CTD request), Inval probes are sent to the processors having copies of the cache line. If P requests both a copy of the cache line as well as exclusive ownership of the cache line (a RdMod request), the system sends a FRdMod probe to the processor currently storing a dirty copy of a cache line of data. In response to the FRdMod probe, the dirty cache line is returned to the system and the dirty copy stored in the cache is invalidated. An Inval probe may be sent to a processor storing a copy of the cache line in its cache when the cache line is to be updated by another processor.

Responses are commands from the system to processors or IOPs which carry the data requested by the processor or an acknowledgment corresponding to a request. For Rd and RdMod requests, the response is a Fill and FillMod response, respectively, each of which carries the requested data. For a CTD request, the response is a CTD-Success (Ack) or CTD-Failure (Nack) response, indicating success or failure of the CTD, whereas for a Victim request, the response is a Victim-Release response.

In the preferred embodiment, the IOP 700 is implemented as an application specific integrated circuit (ASIC).

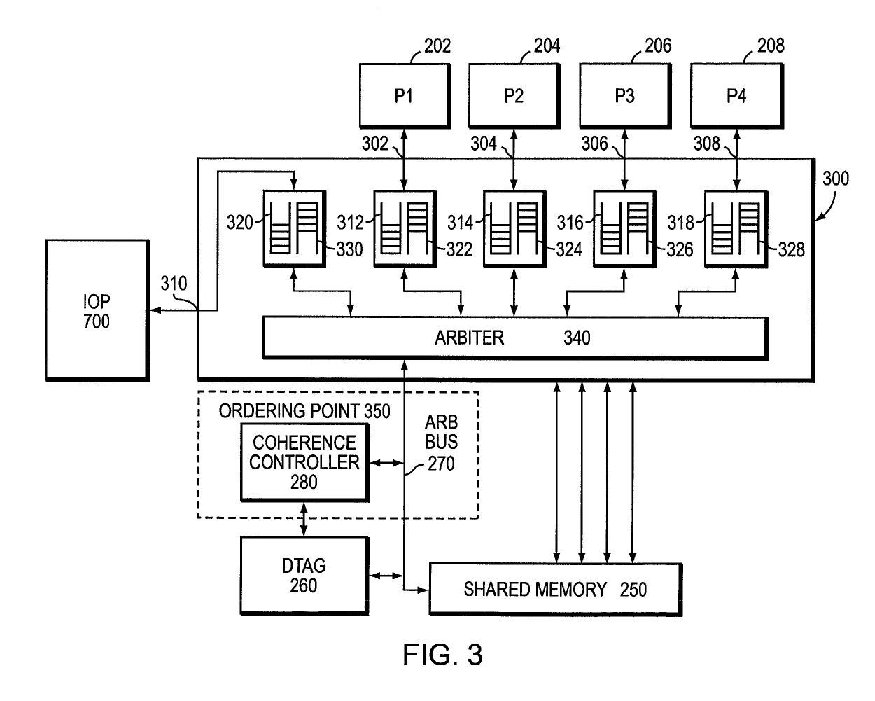

FIG. 3 is a partial, schematic block diagram of system 200 showing the local switch 300 in greater detail. Switch 300 has a plurality of ports 302-310, each of which is coupled to a respective processor (P1-P4) 202-208 and IOP 700 via a full-duplex, bi-directional clock forwarded data link. Each port includes a respective input queue 312-320 for receiving, e.g., a memory reference request issued by its processor and a respective output queue 322-330 for receiving, e.g., a memory reference probe issued by system control logic associated with the switch 300. An arbiter 340 arbitrates among the input queues to grant access to the Arb bus 270 where the requests are ordered into a memory reference request stream. In the illustrative embodiment, the arbiter 340 selects the requests stored in the input queues for access to the bus in accordance with an arbitration policy, such as a conventional round-robin algorithm.

Because of operational latencies through the switch 300 and data paths of the system 200, memory reference requests issued the processors 202-208 and the IOP 700 may complete out-of-order. In some cases, out-of-order completion may affect the consistency of data in the system, particularly for updates to a cache line. Memory consistency models provide formal specifications of how such updates become visible to the entities of the multiprocessor system. In the illustrative embodiment of the present invention, a sequential consistency model is described, although it will be apparent to those skilled in the art that other consistency models, such as weak ordering, may be used.

In a sequentially consistent system, inter-reference ordering is typically imposed by generally requiring completion of each memory reference operation before issuance of the next operation. Since each memory reference operation may consist of a number of commands, the latency of inter-reference ordering is a function of the extent to which each command must complete before the reference is considered ordered. A mechanism is provided for reducing the latency of inter-reference ordering between sets of memory reference operations in a multiprocessor system having a shared memory. The mechanism generally comprises a commit signal that is generated by an ordering point, such as ordering pint 350 of system 200, in response to a memory reference operation issued by a requesting processor for particular data.

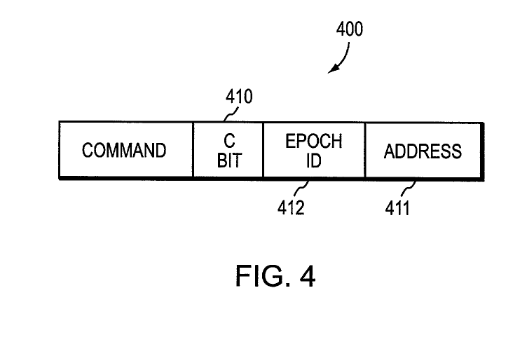

FIG. 4 is a schematic diagram of a commit signal that is preferably implemented as a commit-signal packet structure 400 characterized by the assertion of a single, commit-signal (“C”) bit 410. It will be apparent to those skilled in the art that the commit signal may be manifested in a variety of forms, including a discrete signal on a wire, and in another embodiment, a packet identifying the operation code (opcode) corresponding to the commit signal. The commit-signal 400 facilitates inter-reference ordering by indicating the apparent completion of the memory reference operation to those entities of the system. Specifically, for sequentially consistent behavior, a processor or IOP must receive the commit signal 400 for a first memory reference operation before it retires a second memory reference operation, except for I/O transaction subject to relaxed ordering as described herein. In accordance with the present invention, the commit signal 400 may further include an address field 411 and an epoch identifier (ID) field 412, both of which will be described in more detail below.

Generation of a commit-signal 400 by the ordering point 350 typically occurs upon successful arbitration and access to the Arb bus 270. Total ordering of each memory reference request corresponding to a requested operation constitutes a commit-event for the operation. The commit-signal 400 may be transmitted upon the occurrence of, or after, the commit-event.

The ordering point 350 determines the state of the data items throughout the system and generates probes (i.e., probe packets) to invalidate copies of the data and to request forwarding of the data from the owner to the requesting processor or IOP. For example, the ordering point 350 may generate FRdMod probe to the owner and Inval probes to other processors having shared copies. At this point, the ordering point may also generate the commit-signal 400. The commit-signal 400 and probe packets are loaded into the output queues 322-330 and forwarded to the respective processors or IOP in single, first-in, first-out (FIFO) order.

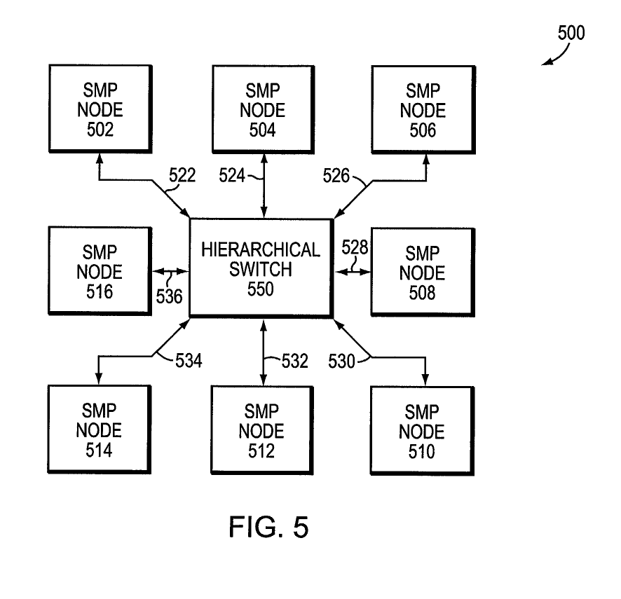

FIG. 5 is a schematic block diagram of a SMP system 500 in accordance with another embodiment of the present invention. SMP system 500 includes a plurality of SMP nodes 502-516, each of which is similar to SMP node 200, interconnected by a hierarchical switch 550. Each of the nodes is coupled to the hierarchical switch 550 by a respective full-duplex, bi-directional, clock forwarded hierarchical switch (HS) link 522-536. Data is transferred between the nodes 502-516 in the form of packets. In order to couple to the hierarchical switch 550, each SMP node further includes a global port interface, described below. Also, in order to provide a shared memory environment, each node is configured with an address space and a directory for that address space. The address space is generally partitioned into memory space and IO space.

Examples of hierarchical switches (including the logic associated with the ports) that are suitable for use in the illustrative embodiment of the invention are described in commonly-assigned U.S. patent application Ser. No. 08/957,298, filed Oct. 24, 1997, now U.S. Pat. No. 6,122,714, and U.S. patent application Ser. No. 08/957,097, filed Oct. 24, 1997, now U.S. Pat. No. 6,108,737, which applications are both hereby incorporated by reference as though fully set forth herein.

In the SMP system 500 of FIG. 5, the ordering point is associated with the hierarchical switch 550. The hierarchical switch 550 is configured to support certain ordering properties in order that commit signals may be gainfully employed. The ordering properties are imposed by generally controlling the order of command packets passing through the switch 550. For example, command packets from any of the hierarchical switch's input buffers may be forwarded in various specified orders to any of its output ports.

Suitable ordering properties for use with the present invention are described in commonly owned U.S. patent application Ser. No. 08/956,861, filed Oct. 24, 1997, now U.S. Pat. No. 6,085,263, which application is hereby incorporated by reference in its entirety.

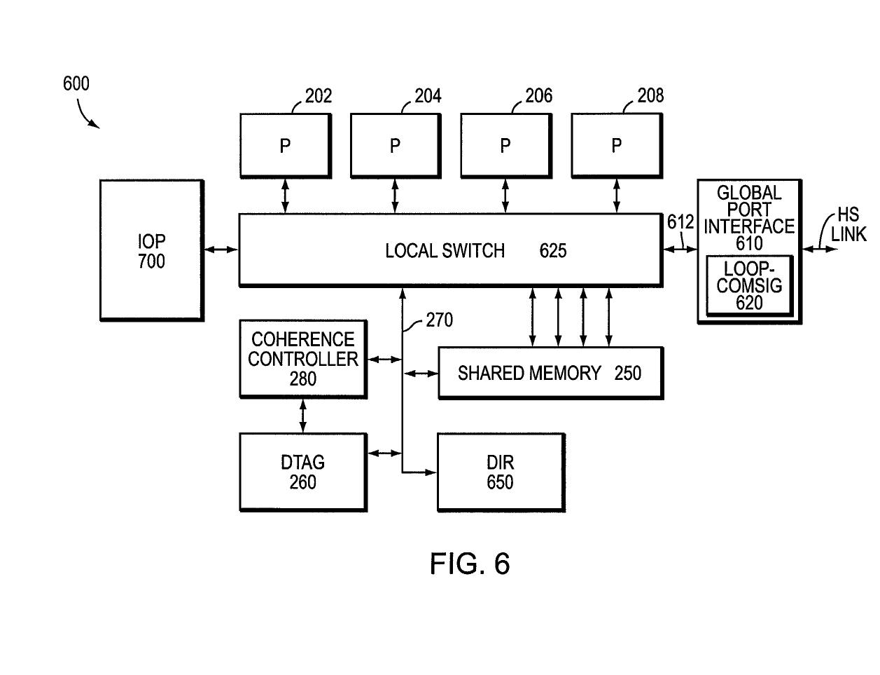

FIG. 6 is a schematic block diagram of an augmented SMP node 600 having a plurality of processors (P) 202-208 interconnected with a shared memory 250, an IOP 700 and a global port interface 610 via a local switch 625. The processors, shared memory and IOP are similar to the those entities of FIG. 2. The local switch 625 is augmented (with respect to switch 300) to include an additional port coupling the interface 610 by way of a full-duplex, clock forwarded global port (GP) data link 612. In addition to the DTAG 260, an additional shared data structure, or directory (DIR) 650, is coupled to Arb bus 270 to administer the distributed shared memory environment of SMP system 500 (FIG. 5).

All commands originate from either a processor or an IOP, where the issuing processor or IOP is referred to as the “source processor.” The address contained in a request command is referred to as the “requested address.” The “home node” of the address is the node whose address space maps to the requested address. The request is termed “local” if the source processor is on the home node of the requested address. Otherwise, the request is termed a “global” request. The Arb bus 270 at the home node is termed the “home Arb bus”. The “home directory” is the directory corresponding to the requested address. The home directory and memory are thus coupled to the home Arb bus for the requested address.

A memory reference operation (request) emanating from a processor or IOP is first routed to the home Arb bus 270. The request is routed via the local switch 625 if the request is local; otherwise, it is considered a global request and is routed over the hierarchical switch 550. In this latter case, the request traverses the local switch 625 and the GP link to the global port, passes over the HS link to the hierarchical switch 550, and is then forwarded over the GP link and local switch of the home node to the home Arb bus 270.

The global port interface 610 includes a loop commit-signal (LoopComSig) table 620 for monitoring outstanding probe-type commands from the SMP node 600. All probe-type commands are multicast by the hierarchical switch 550 to all target nodes as well as to the home node and the source node. The component sent to the source node serves as the commit signal whereas the one to the home node (when the home node is not the source node) serves as the probe-delivery-acknowledgment (probe-ack).

The LoopComSig table 620 is used to determine if a probe-type command corresponding to a particular address x is outstanding from the node at any specific time. This information is used to optimize the generation of comsigs for local commands. Using the LoopComSig table 620, the coherence controller 280 is able to generate commit signals locally and hence reduce the latency of commit signals for a substantial fraction of local commands.

The LoopComSig table 620 has a plurality of entries (not shown), each of which includes an address field and a number of status bits, including a valid bit. The address field stores the address of the cache line for a probe-type command that is currently outstanding. The status bits reflect the status of the outstanding command; alternatively, the status bits may be used to reflect various properties of the outstanding operation. For example, the valid bit indicates whether the allocated entry is valid, thus denoting that this is a probe-type command with outstanding probe-acks.

In the illustrative embodiment, the LoopComSig table 620 is implemented as a content addressable memory device, although other configurations and structures of the table may be used. A suitable configuration and arrangement for table 620 is disclosed in the '263 patent.

Although the table 620 is physically located on the global port interface 610, it may be logically resident on the Arb bus 270 along with the other shared data structures. The DIR, DTAG and LoopComSig table cooperate to maintain coherency of cache lines in the SMP system 500. That is, the DTAG captures all of the state required by the small SMP node cache coherence protocol while the DIR captures the coarse state for the large SMP system protocol. The LoopComSig table 620 captures state information at a finer level. Each of these components interfaces with the global port interface 610 to provide coherent communication between the SMP nodes coupled to the hierarchical switch 550.

As indicated above, each and IOP processor of the system 500 may access portions of shared memory stored at its home node, or at any other SMP node. Because the latency of a local memory access differs from that of a remote memory access, the SMP system 500 is said to have a non-uniform memory access (NUMA) architecture. Further, since the system provides coherent caches, the system is often called a cache-coherent NUMA (CC-NUMA) system. In the illustrative embodiment of the invention, the large SMP system 500 is preferably referred to as a distributed shared memory system, although it may also be considered equivalent to the above classes of systems. Also, the processor consistency model described herein for the large SMP system 500 is preferably sequential consistency, although other processor consistency models such as weak ordering or release consistency may be used.

I/O Bridge:

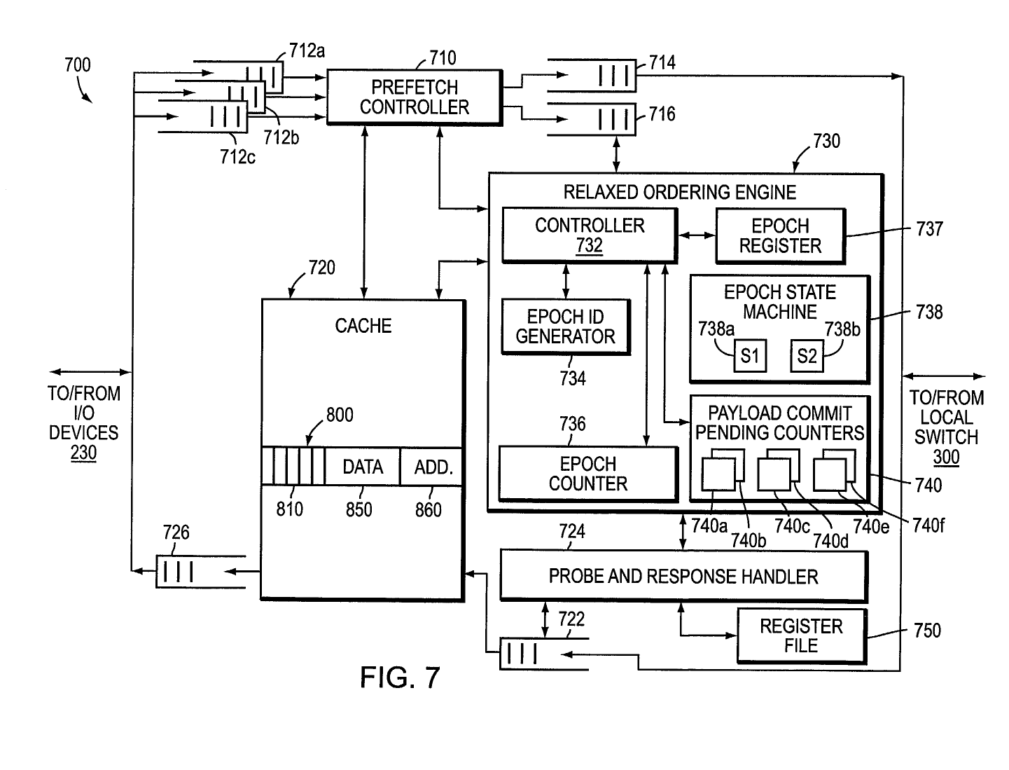

FIG. 7 is a highly schematic, partial block diagram of the high-performance IOP 700 according to the present invention. The IOP 700 preferably includes a prefetch controller 710 coupled to the I/O cache 720. As explained herein, the prefetch controller 710 prefetches data into cache 720 without any ordering constraints, e.g., out-of-order. In the illustrative embodiment, cache 720 is preferably organized as a fully-associative, write-back cache having a plurality of entries 800, each of which includes a field 810 of state bits, a data field 850 and a tag or address field 860. The state bits of field 810 relate to the coherency state of the cache line reflected by the cache entry. The data field 850 contains the data for the cache line and, since the cache is fully-associative, field 860 contains the actual address of the data rather than a tag. If the cache was less than fully-associative, then the tag would be loaded into field 860.

The IOP 700 further has a plurality of input request queues 712a-c, each of which interfaces to the I/O bus 240 (FIG. 2) to receive memory reference operations issued by the I/O devices 230a-c (FIG. 2). The memory reference operations are loaded into a tail of the queues 712a-c. To maintain order of the issued memory references, all operations from a particular I/O device are preferably loaded into a particular one of the input request queues. A head of each input request queue 712a-c is coupled to the prefetch controller 810. As described herein, the prefetch controller 710 examines the address of each memory reference operation at a queue head and compares it with the addresses stored in the cache 720. The prefetch controller 710 is also coupled to at least one output request queue 714 and to at least one retire queue 716. Operations pending in the output request queue 714 are sent to the system over the local switch 300.

IOP 700 further includes one or more probe/response queues 722 leading to cache 720. Probe/response queue 722 is configured to receive probe and response operations from the local switch 300. Operably coupled to the probe/response queue 722 is a probe and response handler 724 for processing received probe and response operations. Disposed between the cache 720 and the I/O devices 230 is an output response queue 726. Responses intended to the I/O devices 230 are placed in queue 726.

IOP 700 also includes a relaxed ordering engine 730 configured to retire select operations in an order that is dependent upon the consistency model using commit-signals. The relaxed ordering engine 730 preferably includes a controller 732 that is operably coupled to an epoch identifier (ID) generator 734, an epoch counter 736, an epoch register 737, an epoch state machine 738 and a plurality of payload commit pending counters 740a-f. The epoch state machine 738 is preferably configured to transition between two states: a last_was_control state (S1) 738a and a last_was_payload state (S2) 738b.

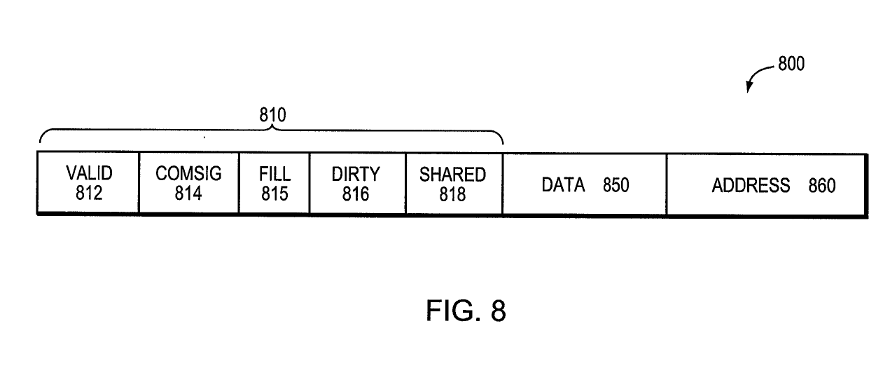

FIG. 8 is a block diagram of a cache entry 800. As noted, each cache entry 800 includes a data field 850, an address field 860 and a plurality of state bits in field 810. The state bits, in turn, comprise a valid bit 812, a commit-signal (ComSig) bit 814, a fill bit 815, a dirty bit 816 and a shared bit 818. If the prefetch controller 710 determines that there is not an entry for an operation, such as a read request, it allocates one by (i) locating a free cache line/block of cache 720, (ii) marking the entry valid by asserting the valid bit 812, (iii) clearing the ComSig, dirty and shared bits 814, 816 and 818, and (iv) loading the address of the request into the address field 860. A cache entry is considered coherent with the system if it has both its valid and ComSig bits 812, 814 asserted. Although it is initially set as indicated above, the valid bit 812 may be cleared in response to the receipt of certain probe commands from the system.

The dirty bit 816 indicates, when asserted, that the state of the cache line is dirty and an asserted shared bit 818 indicates that the state of the cache line is dirty and shared. The ComSig bit 814 is asserted when a commit-signal for the operation that allocated the cache line entry has been received. The allocating operation may be a Rd or RdMod operation. An asserted fill bit 815 indicates that the data for the cache line is present in the cache 820. For example, if an entry has been previously allocated and a prefetch request has been issued to the system to prefetch the data for that entry, a fill (data) response and a commit-signal probe are thereafter returned to the IOP 700. When the fill data response is returned through the probe/response queue 722, the probe and response handler 724 asserts the fill bit 815 for the appropriate cache entry. When the commit-signal returns through the probe/response queue 722, the handler 724 likewise asserts the ComSig bit 814 for the cache entry 800.

Each of the I/O devices 230a-c (FIG. 2) coupled to the IOP 700 issue a series of transactions, such as DMA reads and writes. The chronological sequence of I/O transactions received at the IOP 700 from all I/O devices coupled to the same I/O bus represent a stream of transactions from that bus. Within the stream will be payload read transactions, payload write transactions and control transactions. As described herein, the first occurrence of a payload write transaction in the stream constitutes the start of a new epoch, while the first occurrence of a control transaction constitutes the end of the current epoch. Payload read transactions are preferably ignored for purposes of determining the beginnings and ends of epochs. Epochs are used by the relaxed ordering engine 730 to ensure that the ordering rules for control transactions are satisfied. These rules require that control transactions from the same I/O bus be kept in FIFO order and that control transactions push previously issued payload write transactions from the same bus.

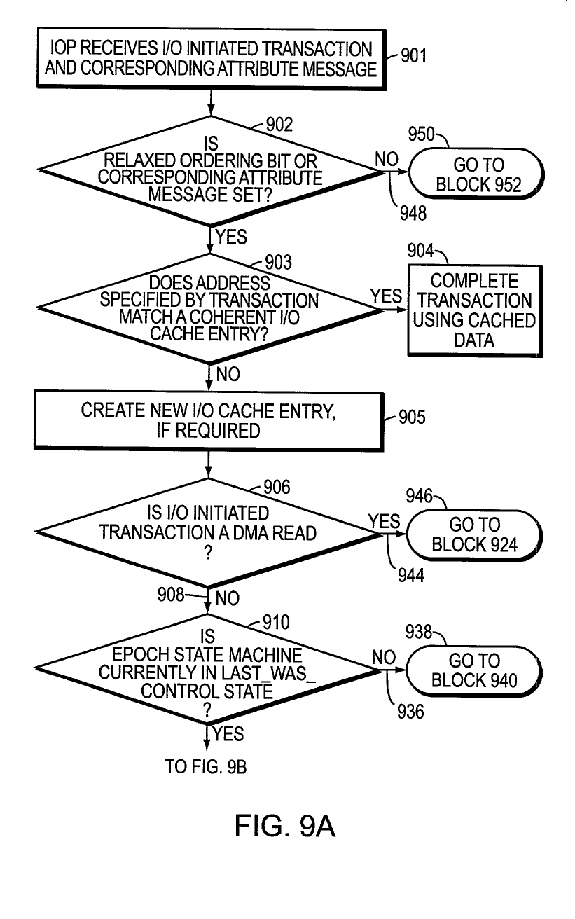

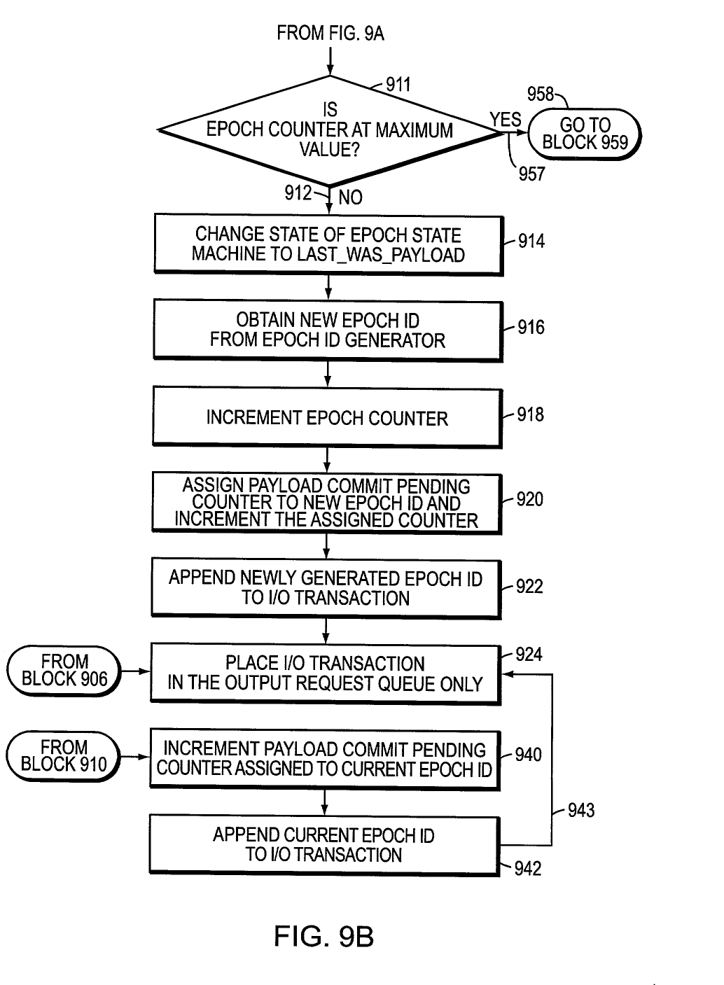

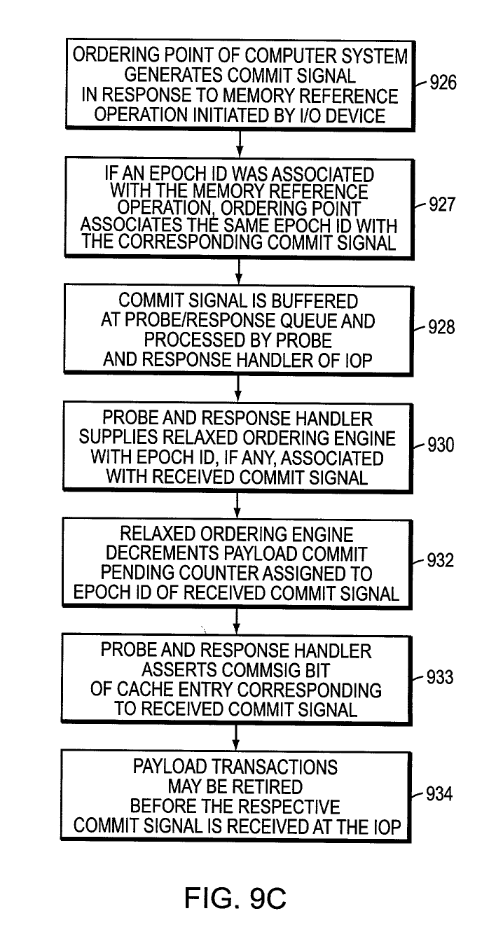

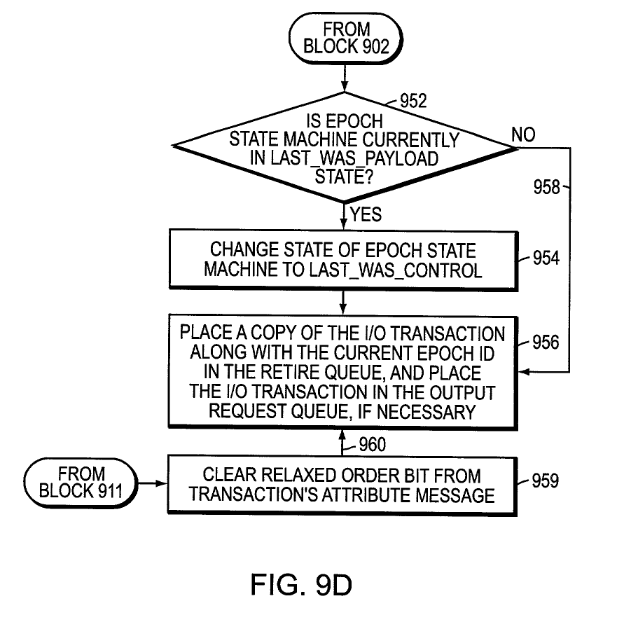

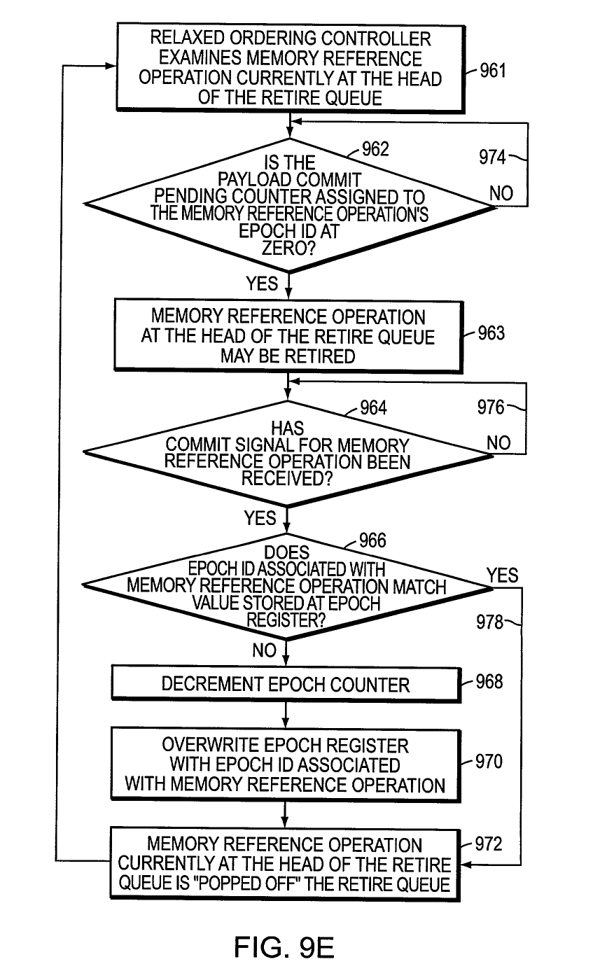

FIGS. 9A-E illustrate a preferred method of operation for the relaxed ordering engine 730 of the present invention. Suppose an I/O device 230 (FIG. 2) issues a transaction, such as a DMA write, onto bus 240 specifying an address and the new data to be written to that address. As part of the transaction, device 230 drives an attribute message 100 onto the bus 240. Suppose further that the I/O device 230 has been enabled to designate transactions to which relaxed ordering rules can be applied, and that device 230 sets the RO field 108 of the attribute message 100, thereby indicating that the DMA write is subject to relaxed ordering.

The attribute message 100 as well as the DMA write transaction are received by the IOP 700 and placed in a selected one of the input request queues, such as queue 712b, as indicated at block 901 (FIG. 9A). The controller 732 of the relaxed ordering engine 730 preferably examines the I/O transaction and its the attribute message 100. Specifically, the controller 732 determines whether the RO field 108 of the attribute message corresponding to the I/O transaction was set, as indicated by decision block 902. Assuming it is, the prefetch controller 710 then compares the address portion of the I/O transaction with the address values stored in the I/O cache 720 to determine whether there is a matching entry, as indicated at decision block 903. If there is a matching entry that is coherent, e.g., both the valid and ComSig bits 812, 814 are set, then the transaction is completed utilizing the coherent data from the I/O cache 720, as indicated at block 904. If the address does not match a coherent cache entry, the prefetch controller 710 creates a new cache entry 800, if required, and loads the address of the DMA transaction into the address field 860, as indicated at block 905.

Controller 732 next determines whether the I/O transaction is a DMA read, as indicated at decision block 906. In this example, the transaction is a DMA write. Accordingly, the controller 732 next determines the current state of the epoch state machine 738, as indicated by No arrow 908 leading to decision block 910. In particular, the controller 732 determines whether the current state, as maintained by state machine 738, is the last_was_control state. If so, the next step is to determine whether sufficient resources are available to handle the payload transaction. In particular, controller 732 determines whether the epoch counter 736 has exceeded a predefined maximum value, as indicated by decision block 911 (FIG. 9B). In the illustrative embodiment, the predefined maximum value is set to the number of payload commit pending registers 740 that have been defined or established at the IOP 700. Assuming resources are available, the controller 732 directs state machine 738 to transition to the last_was_payload state, as indicated by No arrow 912 leading to block 914.

Controller 732 also accesses the epoch ID generator 734 to obtain a new epoch ID, as indicated at block 916. In the preferred embodiment, epoch ID generator 734 is implemented as a counter and controller 732 increments, e.g., increases its value by “1”, the counter to obtain a new epoch ID. Additionally, controller 732 increments epoch counter 736, as indicated at block 918, and assigns a payload commit pending counter, such as counter 740d, to the newly generated epoch ID, as indicated by block 920. Controller 732 also increments the assigned payload commit pending counter 740d, as also indicated at block 920. Controller 732 then returns the newly generated epoch ID to the prefetch controller 710.

The prefetch controller 710 is configured to generate system request messages in response to I/O transactions issued by the I/O devices. For example, if the DMA write transaction is directed to a partial memory block, the prefetch controller 710 may generate a RdMod command requesting exclusive ownership of the address specified by the I/O device as well as the entire data for storage in I/O cache 720 so that the new data being written may be merged into the block. If the DMA write is to an entire memory block, the controller 710 may issue a CTD command requesting exclusive ownership over the address specified by the I/O device, but without obtaining the data. In the preferred embodiment, CTD commands are only issued in response to payload writes. In response to strictly ordered, i.e., control, writes, the prefetch controller 710 preferably obtains the memory block for both full and partial block writes, as such writes may be probed by a system command before they have achieved their required memory consistency. This requirement ensures that probes can return the data associated with the memory block before it has been merged with the new data.

It should be understood that the prefetch controller 710 may also translate addresses from IO space to system space.

In accordance with the present invention, the prefetch controller 710 appends the epoch ID received from controller 732 to the system request, e.g., the RdMod or CTD, as indicated at block 922, and places the system request only in the output request queue 714 for transmission to local switch 300, as indicated at block 924. In the illustrative embodiment, the prefetch controller 710 places the system request at the tail of queue 714, which is organized as a FIFO queue. As indicated above, when the RdMod or CTD reaches the head of queue 714, it is sent to local switch 300 for processing by the home memory 250 for the specified address.

The issued operation, e.g., RdMod or CTD, is ordered by the ordering point in the system, a request for exclusive ownership for the data is forwarded to the current owner, and either an acknowledgement (ACK), indicating that the IOP 700 has been granted exclusive ownership over the data, or a non-acknowledgement (NACK), indicating that the IOP's request has been denied, is returned to the IOP 700. In addition, as indicated at block 926 (FIG. 9C), a commit signal is generated by the ordering point in response to the issued operation, e.g., RdMod or CTD, and returned to the IOP 700. In accordance with the present invention, if an epoch ID had been appended to the issued operation, then the ordering point appends this same epoch ID to the commit signal, as indicated at block 927. The epoch ID may be loaded into field 412 (FIG. 4) of the commit signal 400. Upon receipt of the commit signal at the IOP 700, it is placed in the probe/response queue 722, and processed by the probe and response handler 724, as indicated at block 928. If an epoch ID was appended to the commit signal, the probe and response handler 724 provides it to the relaxed ordering engine 730, as indicated at block 930. The controller 732 locates the payload commit pending counter, e.g., counter 740d, assigned to the epoch ID, and decrements the counter 740d, as indicated at block 932. The handler 724 also asserts the ComSig bit 814 of the respective cache entry, as indicated at block 933.

In the illustrative embodiment, commit signals are not generated for payload read transactions. In addition, epoch IDs are not appended to system commands issued in response to payload read transactions.

Payload transactions, i.e., I/O transactions subject to relaxed ordering, may be completed, e.g., retired, without regard to the status of the ComSig bit 814, as indicated at block 934. For example, because commit signals are not even generated for payload read transactions, they can be completed, e.g., retired, as soon as the data is received at the IOP 700. A payload read is completed by sending the data to the requesting I/O device, typically from the I/O cache 720. A payload write transaction is completed by writing-back the new data to system memory. Although commit signals are generated for payload writes, in accordance with the present invention, completion is not held up pending receipt of the commit signal. In the illustrated embodiment, payload transactions are not added to the retire queue, which as described herein, is used to perform reordering of control transactions. Accordingly, payload transactions can also complete or retire ahead of earlier issued payload transactions.

The IOP 700 may also have a register file 750 that is coupled to the probe and response handler 724. The register file 750 is used to match payload transactions to the system responses returned for prefetches. The register file 750 keeps track of payload transactions that required prefetching, and thus could not be completed immediately using previously cached data. System responses that match corresponding payload transactions within the register file 750 are identified by the probe and response handler 724 and completed accordingly.

It should be understood that the contents of register file 750 could be merged into the I/O cache 720. That is, the function served by the register file 750 could be performed by adding one or more fields to the I/O cache entries.

Returning to FIG. 9A, if, at the time the DMA write transaction was received, the epoch state machine was in the last_was_payload state, then controller 732 increments the payload commit pending counter, e.g., counter 740e, that is assigned to the current epoch ID, as indicated by No arrow 936 leading (via jump block 938) to block 940 (FIG. 9B). The current epoch ID can be determined by checking the current value of the epoch ID generator 734. The controller 732 also returns the current epoch ID to the prefetch controller 710, which appends the epoch ID to the operation being issued, as indicated at block 942. The prefetch controller 710 also places the system operation in the output request queue 714, as indicated by arrow 943 leading back to block 924.

If the I/O transaction is a DMA read, then the response to decision block 906 (FIG. 9A) is Yes. In this case, the relaxed ordering engine 730 takes no action and the prefetch controller 710 simply places the corresponding system operation, e.g., Rd, in the output request queue 714, as indicated by Yes arrow 944 (FIG. 9A) leading (via jump block 946) to block 924 (FIG. 9B).

As indicated above, in addition to issuing transactions that need not be processed in strict ordering, i.e., relaxed ordering transactions, an I/O device 230 can also issue transactions that are to be processed in strict order. For I/O initiated transactions that are to be processed in strict order, the I/O device clears the RO bit 108 of the attribute message 100 corresponding to the I/O transaction. As described above, such transactions are referred to as control transactions. Although control transactions typically correspond to flag and status updating or modifying operations, an I/O device may wish to have strict ordering applied to one or more DMA read or write transactions.

In this case, the response to decision block 902 (FIG. 9A) is No, and the controller 732 then determines whether the epoch state machine 738 is currently in the last_was_payload state, as indicated by No arrow 948 leading (via jump block 950) to decision block 952 (FIG. 9D). If so, the controller 732 directs the state machine to change to the last_was_control state, as indicated at block 954. Under the direction of the relaxed ordering engine 730, the prefetch controller 710 then places the respective system operation along with the current epoch ID in the retire queue 716, as indicated at block 956. That is, the operation is placed at the tail of queue 716. If prefetching is required, then controller 710 also places the system operation at the tail of the output request queue 714, as also indicated at block 956. If the state machine 738 was already in the last_was_control state, then no change in state is warranted and the controller 732 simply directs the prefetch controller 710 to place the operation in the retire queue 716 and, if necessary, in the output request queue 714, as indicated by No arrow 958 leading directly to block 956.

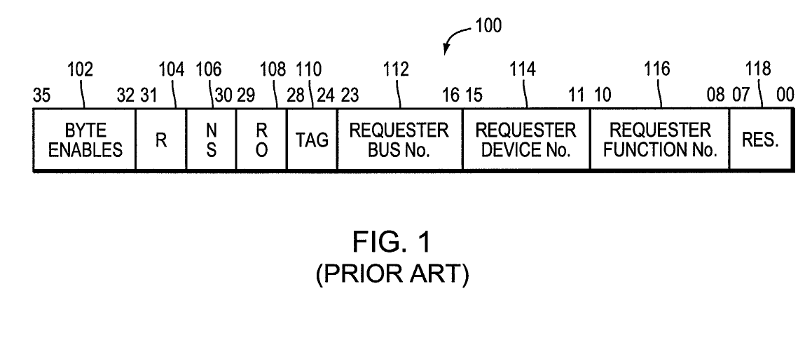

Referring to decision block 911 (FIG. 9B), if the epoch counter is at the maximum value, meaning that there are no resources available to handle a new epoch, controller 732 preferably clears the RO field 108 (FIG. 1) of the transaction's attribute message 100, as indicated by Yes arrow 957 leading (via jump block 958) to block 959 (FIG. 9D). This converts the payload transaction to a control transaction requiring strict ordering. Accordingly, the I/O transaction is placed in the retire queue 716 and in the output request queue 714, as indicated by arrow 960 leading back to block 956.

The preferred steps of retiring control transactions from the retire queue 716 are shown in FIG. 9E. Specifically, the controller 732 examines the system operation located at the head of the retire queue 716, as indicated at block 961 (FIG. 9E). Utilizing the epoch ID associated with the I/O transaction at the head of the retire queue 716, the controller 732 determines whether the payload commit pending counter 740 assigned to that epoch ID is zero, as indicated at decision block 962. If so, then the controller 732 “knows” that all write transactions issued ahead of this control transaction have completed. Accordingly, the I/O transaction may be retired, as indicated at block 963. A read is retired by sending the desired data to the requesting I/O device. A write is retired by merging the data received from the I/O device with the data retrieved for the memory block (in the case of a RdMod), and then by issuing a write-back of the new data to system memory. That is, data received from the I/O device is not merged into the data prefetched from memory (and buffered at the I/O cache 720) until the control write is eligible for retirement. The retiring of transactions is preferably performed by the prefetch controller 710 under the control of the relaxed ordering engine 730.

Next, the controller 732 determines whether the ComSig bit 814 for the cache entry corresponding to the I/O transaction at the head of the retire queue 716 has been asserted, as indicated by decision block 964. Controller 732 may use the memory address of the I/O transaction to search the cache 720 and locate the corresponding entry 800. If the ComSig bit 814 is asserted, then the controller 732 proceeds to “pop”, i.e., remove, the transaction from the head of the retire queue 716. First, however, the controller 732 checks whether the epoch ID associated with the I/O transaction matches the value stored at the epoch register 737, as indicated at block 966. If it does not, then the controller 732 “knows” that the previously popped off transaction represented the end of its epoch. In response, the controller 732 preferably decrements the epoch counter 736, as indicated at block 968, thereby indicating that the resources used by the completed epoch are now available for use with a new epoch. Additionally, the controller 732 overwrites the contents of the epoch register 737 with the epoch ID of the transaction that is currently at the head of the retire 716, i.e., the transaction being popped off, as indicated at block 970. The transaction is then popped off the queue 716 as indicated at block 972.

If the corresponding payload commit pending counter 740 is not at zero, meaning that there are one or more write transactions which have not yet completed, the controller 732 does not retire the transaction and waits for the respective counter to reach zero, as indicated by No arrow 974 which loops back on decision block 962. Similarly, if the ComSig bits 814 is not asserted, then the operation has not yet been committed by the system, and the controller 732 does not proceed to pop the transaction from the queue 716. Instead, the controller 732 waits for the respective commit signal 300 to be asserted, as indicated by No arrow 976 which loops back on decision block 964. Furthermore, if the epoch ID associated with the transaction meeting the conditions for being popped off the retire queue 716 matches the value stored at the epoch register 737, then the transaction is associated with the current epoch ID. In this case, the controller 732 simply pops off the transaction from the retire queue 716 and neither decrements the epoch counter 736 nor changes the value stored at the epoch register 737, as indicated by Yes arrow 978 leading directly to block 972.

Notably, the controller 732 does not attempt to process or retire a control transaction until it reaches the head of the retire queue 716. That is, until the transaction currently at the head of queue 716 is ready for retirement and committed by the system, thereby permitting the controller to pop it off the retire queue 716, the controller 732 does not attempt to retire the second transaction in the queue 716. Accordingly, from the point of view of the I/O devices 230a-c, control transactions are maintained in strict order. Nonetheless, the system can process I/O control transactions, including fetching data as required and returning commit signals out of order to improve the efficiency of the system.

It should be understood that a transaction can be popped of the retire queue 716 before it has retired or completed, provided that the two conditions represented by decision blocks 962 and 964 are met. Furthermore, as indicated above, payload transactions can be retired or completed without regard to the status of previously issued payload or control transactions, and for payload write transaction, before the commit signal has been received at the IOP. More specifically, the prefetch controller 710 can retire a payload read, e.g., send the desired data to the requesting I/O device, as soon as the data is provided to the IOP from the system. Similarly, in response to a payload write transaction, the prefetch controller 710 can merge the data from the I/O device with the data from system memory and write-back the new data to system memory without having to wait for the corresponding commit signal or for any other conditions to be satisfied.

As shown, with the establishment of the novel epochs, a control transaction effectively “pushes” all payload writes having the same epoch ID as the control transaction. Furthermore, all control transactions are processed in strict order with respect to one another regardless of their epoch IDs. That is, while payload transactions assigned to or associated with multiple overlapping and/or concurrent epochs can be retired, the system inhibits control transactions from multiple overlapping and/or concurrent epochs from being retired until all payload writes associated with the subject control transaction's epoch ID have retired.

In the preferred embodiment, IOP 700 preferably has a dedicated retire queue 716 and relaxed ordering engine 730 for each separate PCI/PCI-X bus coupled to the IOP. Control transactions initiated on a particular PCI/PCI-X bus, moreover, are placed in the retire queue 716 and processed by the relaxed ordering engine 730 established for that bus.

It should be understood that the functions performed by the prefetch controller 710 and the relaxed ordering controller 732 may be combined into a single controller.

It should also be understood that the relaxed ordering engine of the present invention can be used in other computer architectures, including systems having only one or two processors.

In a preferred embodiment, the functions performed by the probe and response handler 724 and the register file 750 in completing payload transactions that required prefetching are performed by the relaxed ordering engine 730 and the retire queue(s) 716. That is, rather than provide a register file 750 to record payload transaction that required prefetching, such payload transactions are placed in the retire queue 716. Furthermore, if multiple retire queues 716 are implemented, the relaxed ordering engine 730 is preferably configured, as an optimization, to place payload transactions in any retire queue 716 regardless of the I/O bus that sourced the transaction. When a payload transactions reaches the head of the retire queue, the prefetch controller 710 checks the I/O cache 720 to see whether the requested data has been received and, if so, the transaction is completed and popped off the retire queue. If the data has not yet been received, the payload transaction may still be popped off the retire queue or, alternatively, controller 732 may wait for the data before popping off the transaction.

Use of the retire queues to complete such payload transaction does impose a FIFO ordering relationship to transactions that do not require such order. Nonetheless, it does eliminate the need for a separate register file, thereby simplifying the design and operation of the IOP 700. And, as indicated above, the use of multiple retire queues to process payload transactions sourced from the same I/O bus can improve system efficiency.

The foregoing description has been directed to specific embodiments of the present invention. It will be apparent, however, that other variations and modifications may be made to the described embodiments, with the attainment of some or all of their advantages. For example, if the first control transaction received in a given epoch is followed by one or more control transactions without any intervening payload write transactions, the conclusion of the given epoch may be considered to occur upon the receipt of the last control transaction. Therefore, it is the object of the appended claims to cover all such variations and modifications as come within the true spirit and scope of the invention.

What is claimed is:

1. An apparatus for imposing relaxed ordering on a stream of read and write transactions from an input/output (I/O) device, the transactions indicating whether relaxed or strict ordering is to be applied, the apparatus comprising:
means for assigning epochs to at least some of the transactions in the stream, such that the receipt of a first relaxed order write transaction in the stream constitutes the start of a given epoch and the receipt of one or more strict order transactions constitutes the conclusion of the given epoch;
means for determining when relaxed order write transactions have reached a commit state in accordance with a predefined consistency model; and
means, responsive to the determining means, for inhibiting retirement of a strict order transaction assigned to the given epoch until all of the relaxed order write transactions assigned to the given epoch have reached the commit state.

2. The apparatus of claim 1 further comprising means for inhibiting retirement of a strict order transaction assigned to a later epoch until all strict order transactions assigned to one or more earlier epochs have reached the commit state in accordance with the predefined consistency model.

3. The apparatus of claim 2 wherein the assigning means comprises:
a relaxed ordering controller; and
an epoch identifier (ID) generator operatively coupled to the relaxed ordering controller and configured to produce epoch ID values, and
upon the start of each epoch, the relaxed ordering controller directs the epoch ID generator to produce an epoch ID for assignment to the relaxed order write and strict order transactions of the respective epoch.

4. The apparatus of claim 3 wherein the assigning means further comprises:
an epoch state machine operatively coupled to the relaxed ordering controller and configured for transition between a last_was_payload state and a last_was_control state, and
the relaxed ordering controller
directs the epoch state machine to transition from the last_was_control state to the last_was_payload state in response to a first relaxed order write transaction in the stream, thereby signaling the start of an epoch, and
directs the epoch state machine to transition from the last_was_payload state to the last_was_control state in response to a first strict order transaction in the stream, thereby signaling the conclusion of an epoch.

5. The apparatus of claim 4 wherein
the inhibiting means comprises a plurality of payload commit pending counters operatively coupled to the relaxed order controller, and
the relaxed ordering controller
assigns a selected payload commit pending counter to each epoch,
increments the selected payload commit pending counter in response to each relaxed order write transaction issued during the respective epoch, and
decrements the selected payload commit pending counter in response to receiving a commit signal corresponding to a relaxed order write transaction issued during the respective epoch.

6. The apparatus of claim 5 wherein
the inhibiting means further comprises a retire queue operatively coupled to the relaxed ordering engine, the retire queue organized as a first-in-first-out (FIFO) queue structure having a head and configured to store transactions,
all strict ordered transactions are stored in the retire queue, and
only the transaction disposed at the head of the retire queue is eligible for retirement.

7. The apparatus of claim 5 further comprising:
means for detecting an insufficient resource condition for processing relaxed order transactions; and
means, responsive to the detecting means, for converting relaxed order transactions to strict order transactions during the insufficient resource condition.

8. The apparatus of claim 7 having a fixed number of payload commit pending counters wherein
the detecting means comprises an epoch counter,
the epoch counter is incremented at the start of each epoch and decremented at the conclusion of each epoch,
means for determining whether the epoch counter equals the fixed number of payload commit pending counters.

9. A system in communicating relationship with an I/O device and a computer memory system, the I/O device configured to issue a stream of memory reference operations, including read and write operations, and to specify the application of relaxed or strict ordering to the memory reference operations, the memory system having an ordering point configured to return commit signals to the system in response to memory reference operations becoming committed, the system comprising:
a relaxed ordering controller;
an epoch identifier (ID) generator operatively coupled to the relaxed ordering engine and configured to produce epoch ID values; and
one or more payload commit pending counters operatively coupled to the relaxed ordering engine, wherein,
the relaxed ordering engine
organizes the stream of memory reference operations from the I/O device into epochs, such that the receipt of a first relaxed order write operation in the stream constitutes the start of an epoch and the receipt of a first strict order operation in the stream constitutes the conclusion of the epoch,
upon the start of each epoch, directs the epoch ID generator to produce an epoch ID value for the respective epoch, and assigns a selected payload commit pending counter to the epoch ID value,
associates the respective epoch ID value with all relaxed order write operations issued during the epoch,
increments the selected payload commit pending counter in response to each relaxed order write operation issued during the epoch,
decrements the selected payload commit pending counter in response to receiving a commit signal corresponding to a relaxed order write operation associated with the respective epoch ID, and
delays completion of the strict order operation constituting the conclusion of the epoch until the selected payload commit pending counter reaches zero, thereby confirming that all relaxed order write operations issued during the epoch have committed.

10. The system of claim 9 wherein the relaxed ordering engine delays completion of a given strict order operation in the stream until commit signals have been received at the system for all earlier issued strict order operations in the stream.

11. The system of claim 10 wherein, for a read operation, completion corresponds to transfer of requested data to the I/O device and, for a write operation, completion corresponds to write-back of written data to the memory system.

12. The system of claim 10 further comprising:
an epoch state machine operatively coupled to the relaxed ordering controller and configured for transition between a last_was_payload state and a last_was_control state, wherein
the relaxed ordering controller
directs the epoch state machine to transition from the last_was_control state to the last_was_payload state in response to a first relaxed order write operation in the stream, thereby signaling the start of an epoch, and
directs the epoch state machine to transition from the last_was_payload state to the last_was_control state in response to a first strict order operation in the stream, thereby signaling the conclusion of an epoch.

13. The system of claim 12 further comprising:
a retire queue operatively coupled to the relaxed ordering engine, the retire queue organized as a first-in-first-out (FIFO) queue structure having a head and configured to store memory reference operations, wherein
all strict ordered memory reference operations are stored in the retire queue, and
only the operation disposed at the head of the retire queue is eligible for completion.

14. The system of claim 13 wherein, if the operation at the head of the retire queue is a control operation, the relaxed ordering controller pops the operation from the head of the retire queue provided that the operation is eligible for completion and the commit signal for the operation has been received.

15. The system of claim 10 further comprising:
an I/O cache having a plurality of cache entries for storing data relating to the memory reference operations issued by the I/O device; and
a prefetch controller coupled to the I/O cache, the prefetch controller configured to prefetch data into the cache without any ordering constraints.

16. The system of claim 15 wherein
relaxed ordering operations requiring prefetching are stored in the retire queue, and
if the operation the head of the retire queue is a relaxed ordering operation, the relaxed ordering engine pops the operation from the head of the retire queue provided that the prefetched data has been received.

17. The system of claim 10 wherein the ordering point generates a commit signal in response to total ordering of each issued memory reference operation at the ordering point such that the commit signal indicates apparent completion of the operation rather than actual completion of the operation.

18. The system of claim 10 wherein
the system is disposed in an input/output processor (IOP) that is part of a symmetrical multiprocessor (SMP) computer system, and
the memory system is a shared memory having a non-uniform memory access (NUMA) architecture.

19. The system of claim 18 wherein the IOP is implemented as an application specific integrated circuit (ASIC).

20. A method for imposing relaxed ordering on a stream of memory reference operations issued by an input/output (I/O) device, including read and write operations, the operations indicating whether relaxed or strict ordering is to be applied, a computer memory system having an ordering point issues commit signals in response to memory reference operations becoming committed, the method comprising the steps of:
organizing the stream of memory reference operations into epochs, such that the receipt of a first relaxed order write operation in the stream constitutes the start of an epoch and the receipt of a first strict order operation in the stream constitutes the conclusion of the epoch;
upon the start of each epoch, producing an epoch ID value for the respective epoch, and assigning a payload commit pending counter to the epoch ID value;
associating the respective epoch ID value with all relaxed order write operations issued during the epoch;
incrementing the payload commit pending counter in response to each relaxed order write operation issued during the epoch;
decrementing the payload commit pending counter in response to receiving a commit signal corresponding to a relaxed order write operation associated with the respective epoch ID; and
delaying completion of the strict order operation constituting the conclusion of the epoch until the selected payload commit pending counter reaches zero, thereby confirming that all relaxed order write operations issued during the epoch have committed.

21. The method of claim 20 wherein the step of delaying further requires receipt of commit signals for all earlier issued strict order operations in the stream.

22. The method of claim 21 further comprising the steps of:
providing a state machine configured to transition between a last_was_payload state and a last_was_control state;
transitioning the state machine from the last_was_control state to the last_was_payload state in response to a first relaxed order write operation in the stream, thereby signaling the start of an epoch; and
transitioning the state machine from the last_was_payload state to the last_was_control state in response to a first strict order operation in the stream, thereby signaling the conclusion of an epoch.

23. The method of claim 21 further comprising the steps of:
providing a retire queue that is organized as a first-in-first-out (FIFO) queue structure having a head;
buffering all strict ordered memory reference operations in the retire queue; and
popping the operation off the head of the retire queue where the operation is eligible for completion and the commit signal for the operation has been received.

24. The method of claim 21 further comprising the steps of:
buffering relaxed ordering operations that require prefetching of data at the retire queue; and
popping a relaxed order operation from the head of the retire queue provided that the prefetched data has been received.

25. The method of claim 20 performed at an I/O processor (IOP) that is part of a symmetrical multiprocessor computer system in which the memory system is a shared memory having a non-uniform memory access (NUMA) architecture.

26. The method of claim 25 wherein the IOP is implemented as an application specific integrated circuit (ASIC).
